(19) United States
(12) Patent Application Publication
(10) Pub. No.: US 2009/0140651 A1
(43) Pub. Date: Jun. 4, 2009

(54) Discharge Light Source

(76) Inventors: Masaru Hori, Aichi (JP); Hiroyuki Kano, Aichi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/227,434

(22) PCT Filed: May 21, 2007
(86) PCT No.: PCT/JP2007/060370

§ 371 Date: Jan. 21, 2009

(30) Foreign Application Priority Data
May 22, 2006 (JP) 2006-142113

(51) Int. Cl. H01J 17/26; H01J 61/16; H01J 61/06

(52) U.S. Cl. 313/552; 313/643; 313/631

(57) ABSTRACT

[Problem]

To provide a light-emitting device as a point light source having a broad emission spectrum by a safe and simple process.

[Means for Solving the Problem]

The discharge light source shown in FIG. 1 is composed of an insulated pipe 30 and electrodes 31a and 31b. Projections 32a and 32b extend from the electrodes 31a and 31b. When a voltage is applied to the electrodes 31a and 31b in an argon gas flow through the insulated pipe 30 passing between the projections 32a and 32b, a glow discharge is generated thereby emitting light in the area between the projections 32a and 32b. The interval between the projections 32a and 32b is so narrow that the emitting area is small, and thus the light source serves as a point light source. The emission intensity increases with an increase of the gas flow rate, whereby a continuous broad emission spectrum is produced over the ultraviolet to visible region.

### TECHNICAL FIELD

The present invention relates to a discharge light source as a point light source having a broad emission spectrum.

### BACKGROUND ART

Point light sources having a broad emission spectrum are expected to find applications in the measurement of the amount of radicals in plasmas. For example, molecular radicals such as CF and CF₂ have absorption peaks over a broad spectrum from 200 nm to 250 nm, and so require a point light source which emits light with a broad spectrum in the ultraviolet region. The advantage of a point light source is that it will not affect plasmas irradiated with the light.

Examples of light sources having a broad emission spectrum from the ultraviolet to visible region include a heavy hydrogen lamp, a mercury lamp, a xenon lamp, and a metal halide lamp.

Patent Document 1 describes an arc discharge light source satisfying the above requirements. The arc discharge light source is a very small point light source capable of maintaining a stable arc discharge. It is described therein that a broad emission spectrum is observed in the ultraviolet region when a mixed gas of helium and xenon is used as the ionizing gas for the arc discharge light source.

[Patent Document 1]

Japanese Unexamined Patent Application Publication No. 2005-285679

### DISCLOSURE OF INVENTION

### Problems to be Solved by the Invention

However, the above-described light source uses a high-pressure, expensive, or highly toxic gas, and thus has problems concerning cost and safety. In addition, the discharge site can be hot, which makes it difficult to downsize the light source. Further, the light source may require a large and expensive power source.

Accordingly, an object of the present invention is to provide a discharge light source or a light-emitting device as a point light source having a broad emission spectrum by a safe and simple process, on the basis of discussions about variations of the discharge and emission spectra with the flow rate and pressure of the gas used.

### Means for Solving the Problem

A first aspect of the present invention is an atmospheric pressure discharge light source including electrodes composed of first and second electrodes arranged with a minute interval therebetween, and a transportation unit between the first and second electrodes for transporting argon, nitrogen, or air as an ionizing gas, the ionizing gas being fed through the minute interval between the first and second electrodes while discharge is performed.

When an ionizing gas is fed between the electrodes of the discharge light source with a high voltage applied to the electrodes, a glow discharge is generated between the electrodes to emit light. When argon, nitrogen, or air is used as the gas, the emission intensity increases with an increase of the gas flow rate. The reason for this is as follows. When the gas flow rate is slow, light emission occurs even outside the electrodes. With an increase of the gas flow rate, light emission is concentrated between the electrodes, which results in an increase of the emission intensity.

The interval between the electrodes is so narrow that the light emission is concentrated in the minute area between the electrodes. Accordingly, a point light source is provided as a result of the increase of the gas flow rate. In addition, a continuous and broadened emission spectrum is produced as a result of the increase of the emission intensity.

The electrodes are made of, for example, stainless steel or molybdenum. The interval between the electrodes is preferably from 0.5 to 1.0 mm. The gas flow rate between the electrodes is preferably 127 m/s or more. When the gas flow rate is 127 m/s or more, the light source gives a sufficient emission intensity with a broad emission spectrum extending from the ultraviolet to visible region. The gas flow rate is preferably from 50 to 400 m/s. If the gas flow rate is 50 m/s or less, the light emitted is not continuous, which is not preferred, and if 400 m/s or more, the gas tends to be saturated, which is also not preferred.

A second aspect of the present invention is a discharge light source according to the first aspect of the present invention, which further includes an insulated pipe for introducing the gas into the minute interval between the first and second electrodes, wherein the first and second electrodes are arranged near the gas outlet of the insulated pipe.

The insulated pipe is preferably used to introduce the gas to the area between the electrodes. The insulated pipe facilitates the feeding of the gas to the area between the electrodes. Arrangement of the electrodes near the gas outlet of the insulated pipe limits the discharge area to the neighborhood of the gas outlet, which results in a remarkable increase of discharge stability. The electrodes may be directly connected to the insulated pipe. The inside diameter of the insulated pipe is preferably from 0.5 mm to 1.0 mm. The insulated pipe is made of, for example, ceramic.

A third aspect of the present invention is a discharge light source according to the first or second aspect of the present invention, wherein a projection having a saw-tooth tip is provided on each of the first and second electrodes thereby forming a minute interval therebetween.

The projections on the electrodes facilitate the formation of a minute interval between the electrodes, and hinder spreading the discharge area. In addition, the saw-tooth tips prevents spreading of the discharge area. As a result of this, a discharge is generated in the area surrounded by the electrodes and projections. As a result of this, a point light source is produced by a simplified process.

A fourth aspect of the present invention is a discharge light source according to any one of the first to third aspects of the present invention, wherein the minute interval between the first and second electrodes is 1 mm or less.

The discharge area, or the emitting area depends on the interval between the electrodes. The emitting area expands with an increase of the interval, and shrinks with a decrease of the interval. Therefore, in order to obtain a point light source, the interval between the electrodes is preferably narrow. When the interval between the electrodes is 1 mm or less, the emitting area is narrowed, whereby a point light source is readily produced.

A fifth aspect of the present invention is a discharge light source according to any one of the first to fourth aspects of the present invention, wherein the transportation unit circulates the gas to the minute interval between the first and second electrodes, and controls the flow rate and pressure of the gas.

The transportation unit facilitates the control of the flow rate and pressure of the gas to stabilizes these factors. As a result of this, a stable emission spectrum is produced, and the gas consumption is suppressed.

A sixth aspect of the present invention is a discharge light source according to the fifth aspects of the present invention, wherein the gas pressure is 0.8 atm or more.

When the gas pressure is 0.8 atm or more, the emission intensity depends not on the pressure but on the flow rate, and increases with an increase of the flow rate. Accordingly, the emission intensity is controlled by the flow rate alone, which facilitates the control of the emission intensity. In addition, the light-emitting device can be used at low pressures, which offers a high level of safety.

The upper limit of the pressure is 2 atm. If the pressure is beyond the upper limit, the glass material used may be broken.

In the first to fifth aspects of the present invention, the gas is preferably argon. The reason for this is that argon stabilizes the discharge, which results in the stabilization of the emission spectrum.

### Advantageous Effect of the Invention

When the discharge light source of the first aspect of the present invention is used at a high gas flow rate, a point light source producing a broad emission spectrum is obtained. Since the light source uses argon, nitrogen, or air, it is inexpensive and safe. The increased gas flow rate also increases the heat dissipation effect of the electrodes. The discharge mode is glow, so that the discharge current is about 10 mA. The point light source achieves a high heat dissipation effect and requires a low current, which allows miniaturization of the light source.

According to the second aspect of the present invention, the use of the insulated pipe for introducing the gas more stabilizes the discharge according to the first aspect of the present invention, and the saw-tooth projections according to the third aspect of the present invention facilitates the production of a point light source. In particular, as shown by the fourth aspect of the present invention, the production of a point light source is further facilitated when the interval between the electrodes is 1 mm or less.

As shown by the fifth aspect of the present invention, light emission is further stabilized through the use of the transportation unit. Further, as shown by the sixth aspect of the present invention, the emission intensity is readily controlled when the gas pressure is 0.8 atm or more.

### BRIEF DESCRIPTION OF THE DRAWINGS

FIG. 1 is a structural drawing of the light-emitting device of Example 1.

FIG. 2 is a structural drawing of the discharge light source composing the light-emitting device of Example 1.

FIG. 3 is a structural drawing of the electrodes included in the discharge light source.

FIG. 4 is a graph showing emission spectra produced by the light-emitting device of Example 1 using argon at a pressure of 1.2 atm.

FIG. 5 is a graph showing emission spectra produced by the light-emitting device of Example 1 using argon at a pressure of 1.0 atm.

FIG. 6 is a graph showing emission spectra produced by the light-emitting device of Example 1 using argon at a pressure of 0.8 atm.

FIG. 7 is a graph showing emission spectra produced by the light-emitting device of Example 1 using argon at a pressure of 0.6 atm.

FIG. 8 is a graph showing emission spectra produced by the light-emitting device of Example 1 using argon at a flow rate of 127 m/s.

FIG. 9 is a graph showing emission spectra produced by the light-emitting device of Example 1 using argon at a flow rate of 170 m/s.

FIG. 10 is a graph showing emission spectra produced by the light-emitting device of Example 1 using air at a pressure of 0.8 atm.

FIG. 11 is a graph showing emission spectra produced by the light-emitting device of Example 1 using air at a pressure of 0.6 atm.

FIG. 12 is a graph showing emission spectra produced by the light-emitting device of Example 1 using air at a flow rate of 127 m/s.

FIG. 13 is a graph showing emission spectra produced by the light-emitting device of Example 1 using nitrogen at a pressure of 0.8 atm and different flow rates.

FIG. 14 is a graph of comparative example, showing emission spectra produced by the light-emitting device of Example 1 using helium at a pressure of 0.8 atm and different flow rates.

### REFERENCE NUMERALS

10 discharge light source
11 air pump
16 to 20 valves
30 insulated pipe
31a, 31b electrodes
32a, 32b projections
33 area surrounded by projections

### BEST MODE FOR CARRYING OUT THE INVENTION

The present invention is further described below on the basis of specific examples. However, the present invention is not limited to these examples.

### EXAMPLE 1

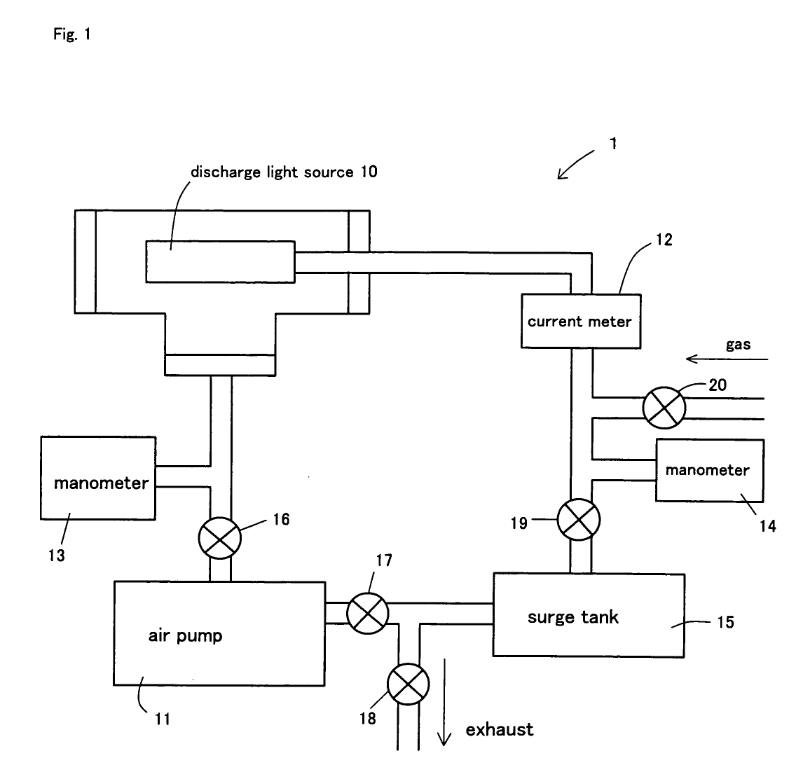

FIG. 1 shows a light-emitting device including the light-emitting source of Example 1. The light-emitting device is composed of a circulation device 1 including a discharge light source 10 and a transportation unit. The discharge light source 10 is connected to the circulation device 1 for circulating a gas. The gas can be circulated while enclosed in the light-emitting device. As shown in FIG. 1, the gas is circulated by an air pump 11 through piping. The circulation device 1 includes a flowmeter 12, pressure meters 13 and 14, and a surge tank 15. The piping is provided with valves 16 to 20 for controlling the flow rate and pressure. In particular, the valve 18 controls the gas emission from the circulation device 1, and the valve 20 controls the gas inflow into the circulation device 1.

The circulation device 1 is used to suppress the gas consumption and to stabilize the emission spectrum. The circulation device 1 stabilizes the flow rate and pressure, thus stabilizing the discharge and emission spectrum.

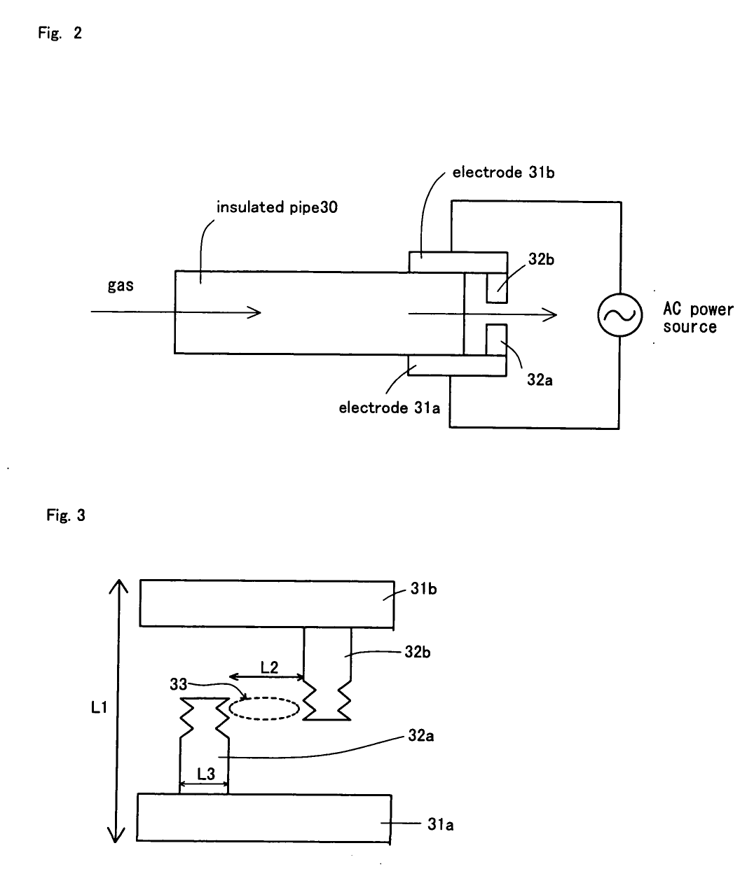

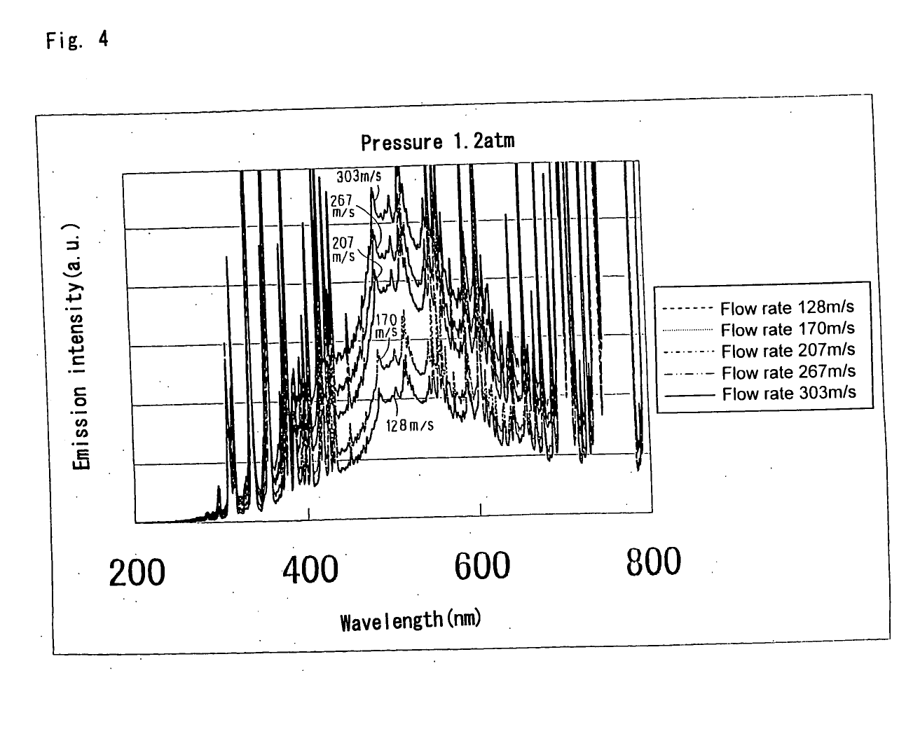

FIG. 2 shows the discharge light source 10 composed of an insulated pipe 30 and plane electrodes 31a and 31b. The insulated pipe 30 is connected to the piping of the circulation device 1. The inside diameter of the insulated pipe 30 is 0.5 mm. The insulated pipe 30 is more effective when its inside diameter is from 0.5 to 1 mm. The electrodes 31a and 31b are partially in contact with the upper and lower sides of the insulated pipe 30 so as to sandwich the insulated pipe 30. FIG. 3 is an enlarged view of the electrodes 31a and 31b from the gas outlet direction. Two projections 32a and 32b extend from the electrodes 31a and 31b at the sites not in contact with the insulated pipe 30 so as to be perpendicularly opposed to each other. The interval L1 between the electrodes 31a and 31b is 10 mm, the interval L2 between the two projections 32a and 32b is 1.0 mm, and the width L3 of the projections 32a and 32b is 3 mm. The tips of the projections have a saw-tooth pattern made up of triangles. The triangles prevent spreading of the discharge area thereby narrowing it. The insulated pipe is made of ceramic, and the electrodes are made of stainless steel.

The light-emitting device of Example 1 is operated as follows.

A gas is fed from the piping of the circulation device 1 into the insulated pipe 30, and blown out through the outlet of the insulated pipe 30 toward an area 33. The gas blown out passes through the area 33, and is fed to the piping of the circulation device 1. The gas is circulated by the air pump 11 within the circulation device 1, and its flow rate and pressure are controlled with the valves 16 to 20. The valves 18 and 20 may be closed thereby causing the gas to be circulated while enclosed in the light-emitting device. When an alternating voltage is applied to the electrodes with the gas fed to the area 33 as described above, a discharge and light emission occur in the vicinity of the area 33. The area 33 is so narrow that the emitting area is also narrow. In Example 1, an alternating voltage of 60 Hz, 6 kV was applied.

The relationships between the emission spectrum produced by the light-emitting device, and the flow rate, pressure, and type of the gas were studied. The results are discussed below. The flow rate and pressure were measured with the flowmeter 12 and pressure meter 13, respectively.

Firstly, the relationship between the emission spectrum and flow rate was studied using an argon gas at a constant pressure.

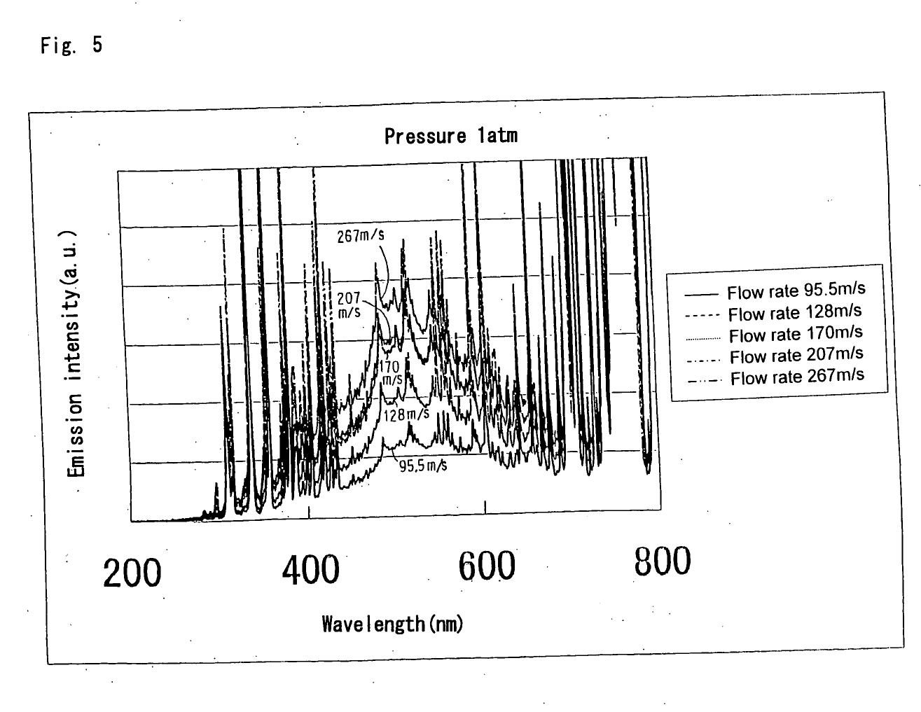

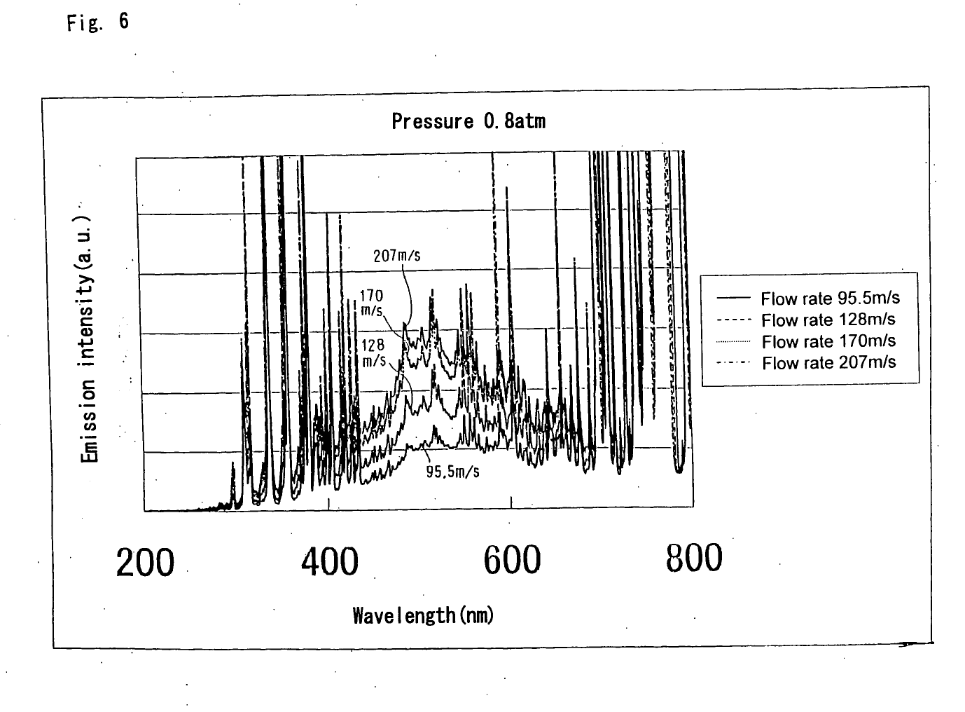

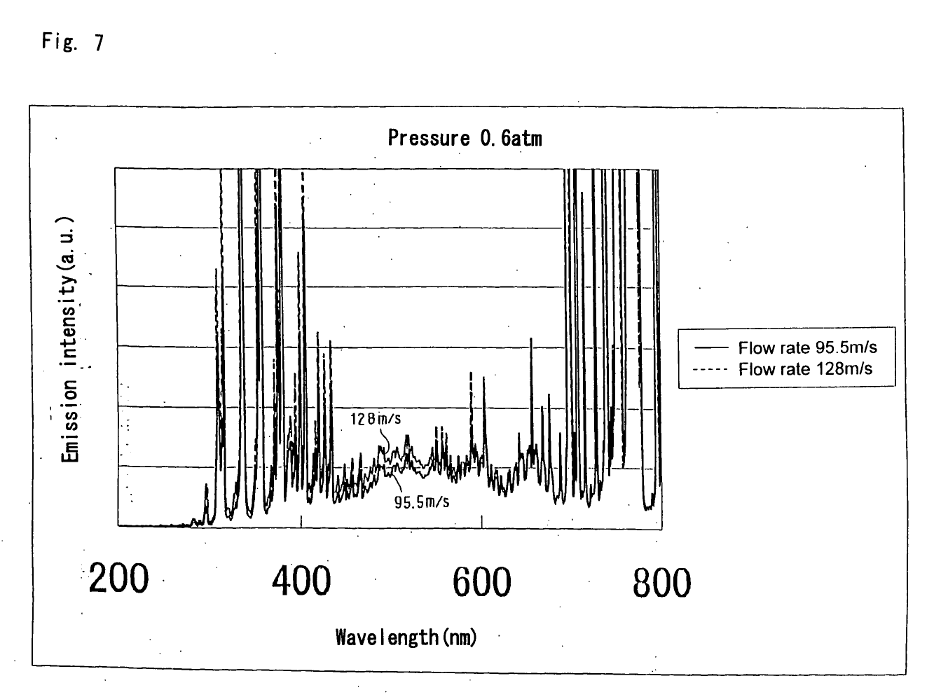

The result indicates that, when the pressure was 0.8 atm or more, the emission intensity increased with an increase of the flow rate. Of special note is that the emission intensity increased even in the ultraviolet region with an increase of the flow rate. FIG. 4 is a graph showing emission spectra measured at a constant pressure of 1.2 atm and different flow rates, i.e., 128 m/s, 170 m/s, 207 m/s, 267 m/s, and 303 m/s. FIG. 4 indicates that the emission intensity increased and the spectrum broadened with an increase of the flow rate. It is found that the spectrum width broadens with an increase of the flow rate from 128 m/s to 303 m/s. FIG. 5 is a graph showing emission spectra measured at a constant pressure of 1.0 atm and different flow rates, i.e., 95.5 m/s, 128 m/s, 170 m/s, 207 m/s, and 267 m/s. FIG. 6 is a graph showing emission spectra measured at a constant pressure of 0.8 atm and different flow rates, i.e., 95.5 m/s, 128 m/s, 170 m/s, and 207 m/s. It is found that the spectrum width is markedly broadened by the increase of the flow rate from 95.5 m/s to 207 m/s. Both of FIG. 5 and FIG. 6 indicate that, as with FIG. 4, the emission intensity increased and the spectrum broadened with an increase of the flow rate. FIG. 7 is a graph showing emission spectra measured at a constant pressure of 0.6 atm and different flow rates, i.e., 95.5 m/s and 128 m/s. It is that the emission intensity or spectrum width does not markedly vary with an increase of the flow rate. Accordingly, the pressure is preferably 0.8 atm or more. Although the spectrum is expected to be broadened at a pressure of 1.2 atm or more, the pressure is preferably from 0.8 atm to 1.2 atm according to the results of the experiment.

The reason why the emission intensity increases with an increase of the flow rate is as follows: light emission occurs even outside the electrodes at lower flow rates, but light emission is concentrated in the area between the electrodes at higher flow rates. Thus, the emitting area shrinks with an increase of the flow rate, thus serving as a point light source.

Secondly, the relationship between the emission spectrum and pressure was studied using an argon gas at a constant flow rate.

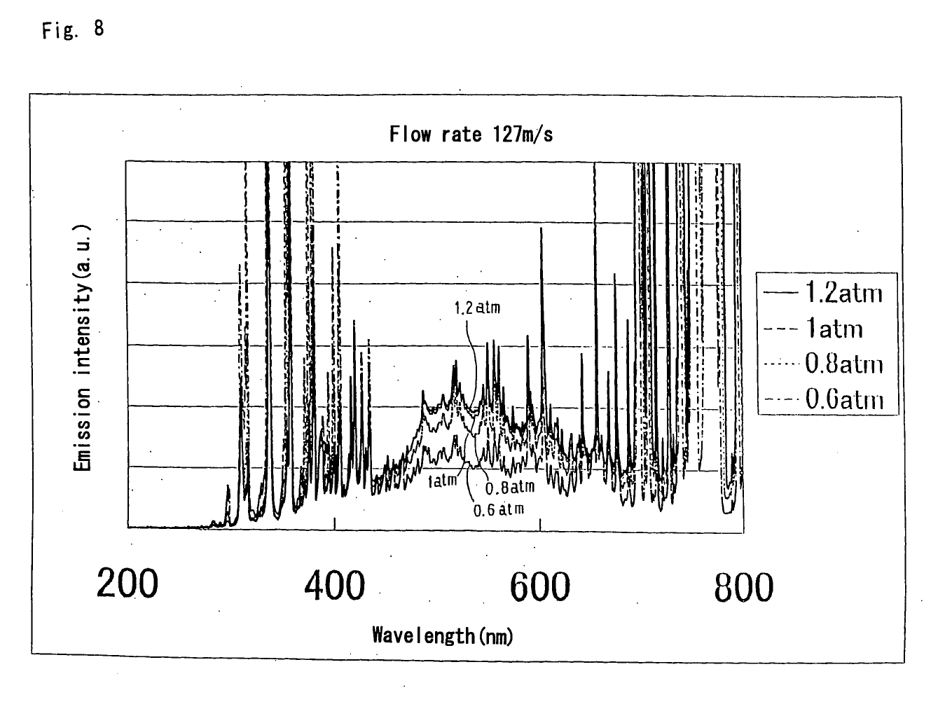

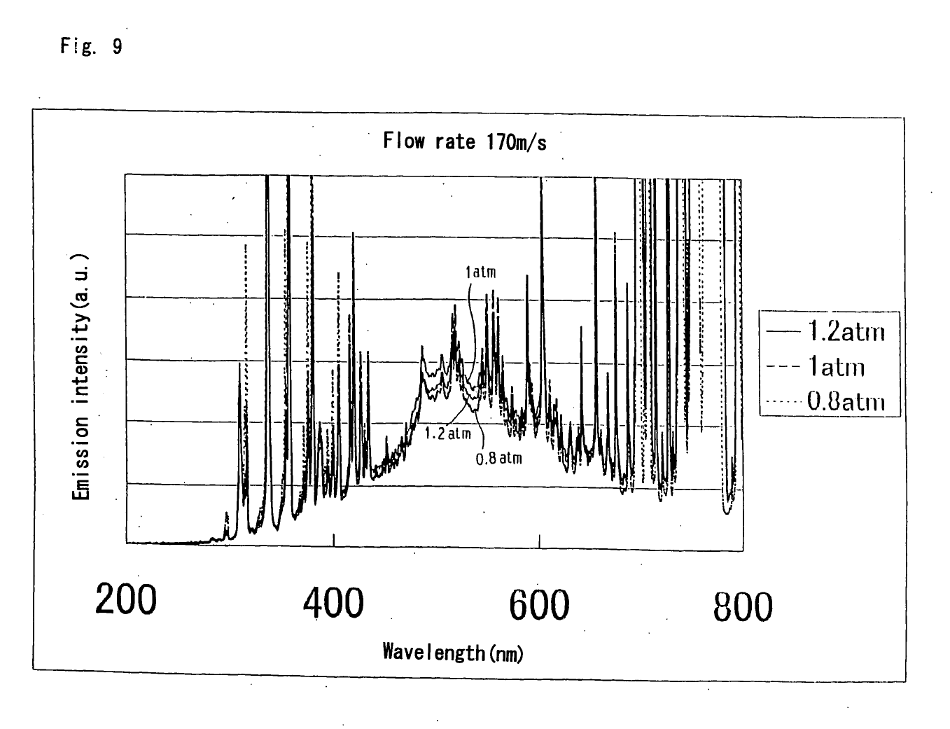

The results indicate that the emission intensity did vary with the flow rate at a pressure of 0.8 atm or more. FIG. 8 is a graph showing emission spectra measured at a constant flow rate of 127 m/s and different pressures, i.e., 0.6 atm, 0.8 atm, 1.0 atm, and 1.2 atm. FIG. 8 indicates that the emission intensities at the pressures 0.8 atm, 1.0 atm, and 1.2 atm were similar. FIG. 9 is a graph showing emission spectra measured at a constant flow rate of 170 m/s and different pressures, i.e., 0.8 atm, 1.0 atm, and 1.2 atm.

FIG. 9 indicates that the emission intensities were similar irrespective of the pressure. Accordingly, the pressure is preferably 0.8 atm or more. In the experiment, the pressure was increased up to 1.2 atm. Therefore, the pressure range extending at least from 0.8 to 1.2 atm can be regarded as preferable.

According to the above results, in the emission spectra produced using an argon gas and the light-emitting device of Example 1 at pressures of 0.8 atm or more, the emission intensity does not depend on the pressure but on the flow rate, and the emission intensity increases with an increase of the flow rate.

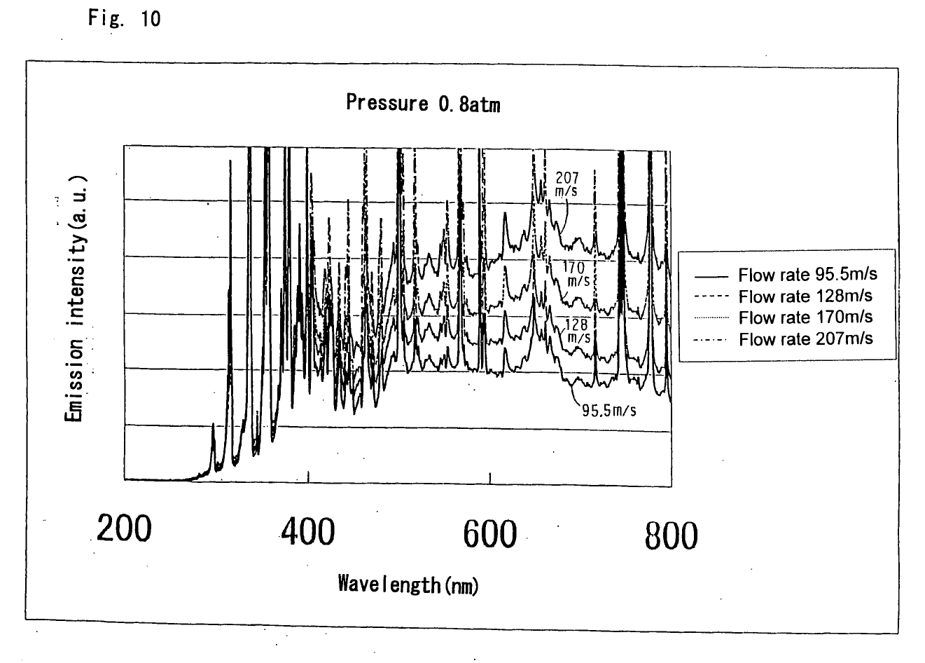

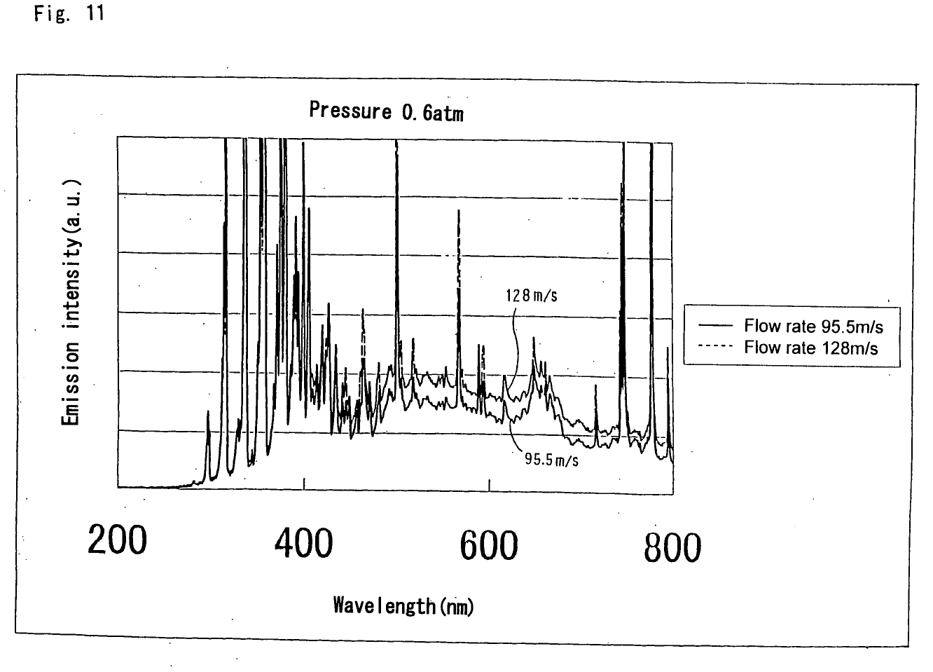

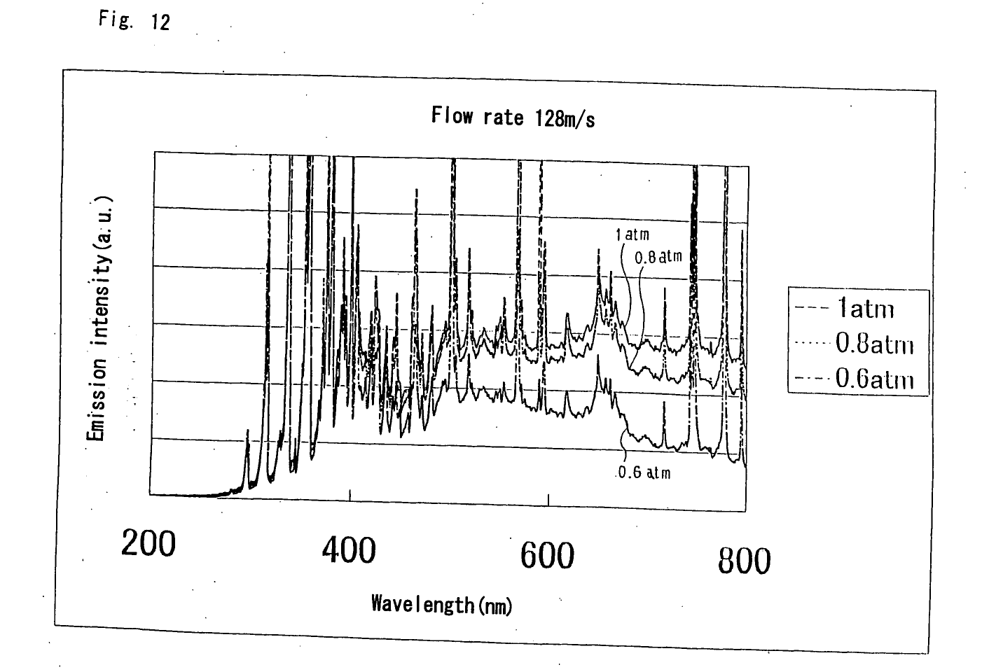

Even when the gas was nitrogen or air at a pressure of 0.8 atm or more, the emission intensity did not depend on the pressure but on the flow rate, and the emission intensity tended to increase with an increase of the flow rate. The following spectra were produced using air, showing the above-described tendency. FIG. 10 is a graph showing emission spectra measured at a constant pressure of 0.8 atm, and different flow rates, i.e., 95.5 m/s, 128 m/s, 170 m/s, and 207 m/s. FIG. 10 indicates that the emission intensity increased with an increase of the flow rate. The flow rate range extending at least from 95.5 m/s to 207 m/s can be regarded as a preferable range when the discharge gas is air. FIG. 11 is a graph showing emission spectra measured at a constant pressure of 0.6 atm, and different flow rates, i.e., 95.5 m/s and 128 m/s. FIG. 11 indicates that the emission intensity negligibly varied with the flow rate. According to the result, the pressure is preferably 0.8 atm or more when air is used. FIG. 12 is a graph showing emission spectra measured at a constant flow rate of 128 m/s, and different pressures, i.e., 0.6 atm, 0.8 atm, and 1.0 atm. FIG. 12 indicates that there was no marked difference in the emission intensities at 0.8 atm and 1.0 atm. According to the result, the pressure must be about 0.8 atm, and is preferably from 0.8 to 1.2 atm.

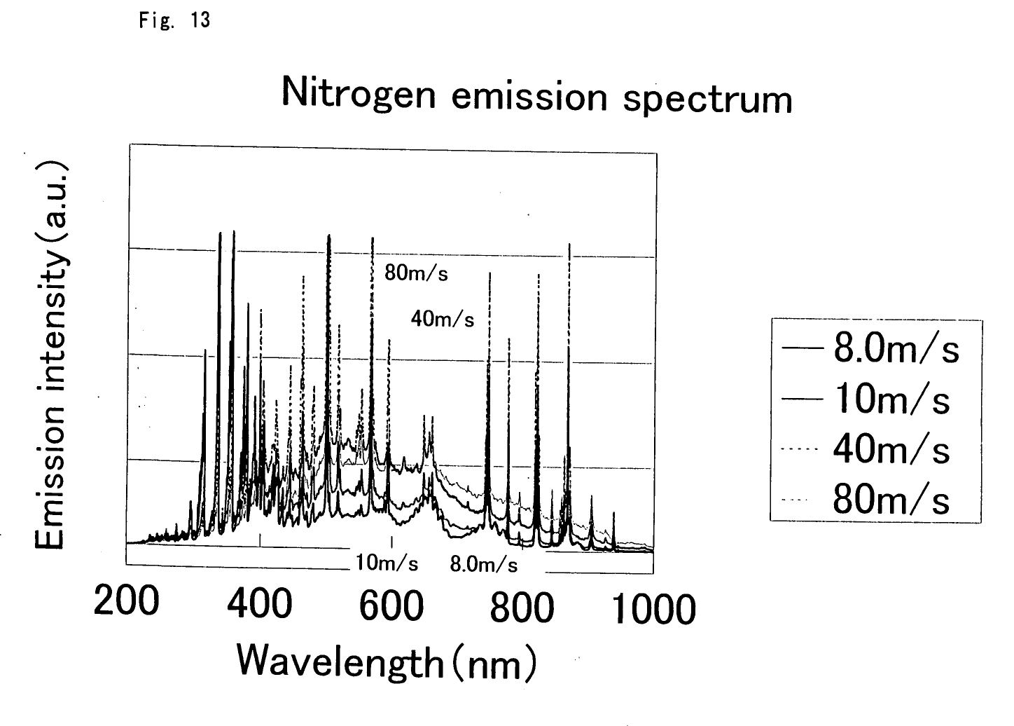

FIG. 13 is a graph showing emission spectra measured using a nitrogen gas as the discharge gas at a constant pressure of 0.8 atm and different flow rates, i.e., 8.0 m/s, 10 m/s, 40 m/s, and 80 m/s. The inside diameter (diameter) of the insulated pipe 30 was 1 mm. FIG. 13 indicates that the emission intensity increased with an increase of the flow rate. The flow rate range extending at least from 8.0 m/s to 80 m/s can be regarded as a preferable range when nitrogen is used as the discharge gas.

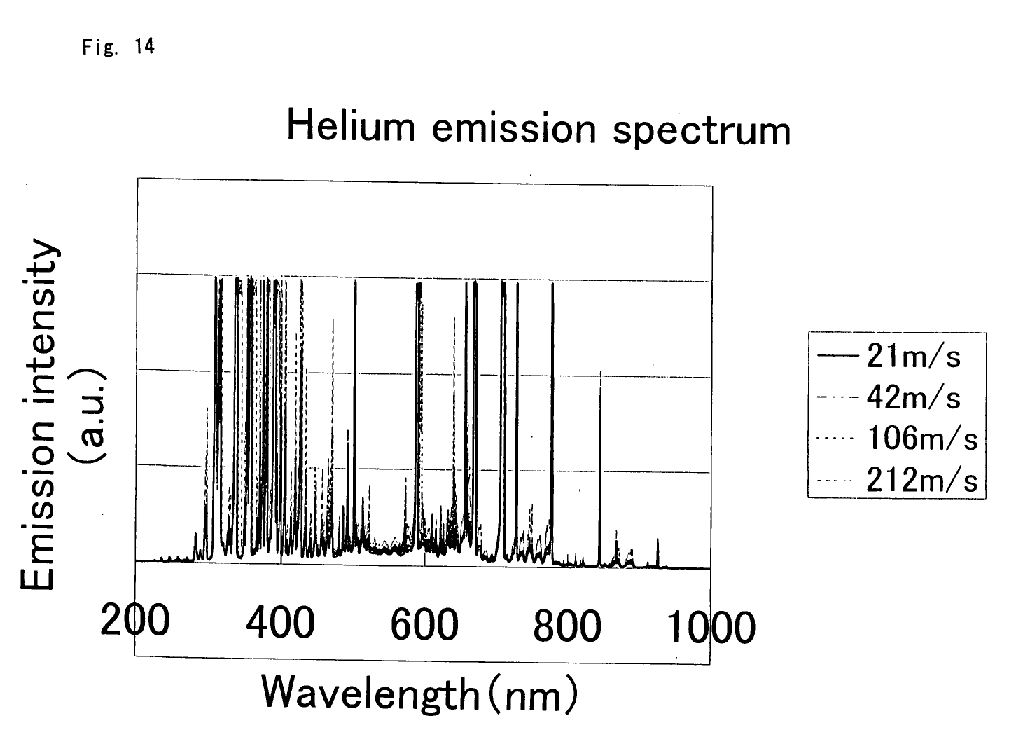

As shown in FIG. 14, when helium was used as the discharge gas, the emission intensity did not vary with an increase of the flow rate.

Comparisons between the spectra produced using argon, nitrogen and air indicate that the discharge and emission spectrum were stable when argon was used.

As described above, a broad and continuous emission spectrum extending from the ultraviolet to visible region was produced by the light-emitting device of Example 1 using an argon gas at a pressure of 0.8 atm or more and a high flow rate, whereby a light-emitting device as a point light source giving a stable emission spectrum has been provided. In addition, the device generates a discharge in a gas flow, thereby giving a heat dissipation effect.

The light source composed of the light-emitting device of Example 1 emits light having a broad spectrum, and thus can be used to identify the types of various radicals in a plasma, and to measure their densities. Since the light source is a point light source, it will not affect the plasma irradiated with the light, which allows accurate measurement.

When a discharge gas is fed into the discharge light source of Example 1 without being connected to the circulation device 1, the emission spectra produced is inferior in stability to that produced in Example 1 wherein the discharge light source is connected to the circulation device 1. The discharge gas may be enclosed in a lamp body, wherein the discharge gas is transported and circulated between the electrodes.

1-6. (canceled)

7. An atmospheric pressure discharge light source, comprising:
electrodes including first and second electrodes arranged with a minute interval therebetween; and
a transportation unit between the first and second electrodes for transporting argon, nitrogen, or air as an ionizing gas,
the ionizing gas being fed through the minute interval between the first and second electrodes while discharge is performed.

8. The discharge light source according to claim 7, which further comprises an insulated pipe for introducing the gas into the minute interval between the first and second electrodes, wherein the first and second electrodes are arranged near the gas outlet of the insulated pipe.

9. The discharge light source according to claim 7, wherein a projection having a saw-tooth tip is provided on each of the first and second electrodes thereby forming the minute interval therebetween.

10. The discharge light source according to claim 8, wherein a projection having a saw-tooth tip is provided on each of the first and second electrodes thereby forming the minute interval therebetween.

11. The discharge light source according to claim 7, wherein the minute interval between the first and second electrodes is 1 mm or less.

12. The discharge light source according to claim 8, wherein the minute interval between the first and second electrodes is 1 mm or less.

13. The discharge light source according to claim 9, wherein the minute interval between the first and second electrodes is 1 mm or less.

14. The discharge light source according to claim 7, wherein the transportation unit circulates the gas to the minute interval between the first and second electrodes, and controls a flow rate and pressure of the gas.

15. The discharge light source according to claim 11, wherein the transportation unit circulates the gas to the minute interval between the first and second electrodes, and controls a flow rate and pressure of the gas.

16. The discharge light source according to claim 13, wherein the transportation unit circulates the gas to the minute interval between the first and second electrodes, and controls a flow rate and pressure of the gas.

17. The discharge light source according to claim 14, wherein the gas pressure is 0.8 atm or more.

18. The discharge light source according to claim 15, wherein the gas pressure is 0.8 atm or more.

19. The discharge light source according to claim 16, wherein the gas pressure is 0.8 atm or more.
